(19) United States
(12) Patent Application Publication
(10) Pub. No.: US 2026/0368053 A1
(43) Pub. Date: Nov. 19, 2026

(54) AUTONOMOUS MOBILITY SAFETY ANALYSIS METHOD AND ELECTRONIC DEVICE

(71) Applicant: Industrial Technology Research Institute, Hsinchu (TW)

(72) Inventors: Shih-Yi Chiu, Taoyuan City (TW); Chen-Hui Hu, Taichung City (TW); Wen-Chieh Lin, Hsinchu City (TW)

(73) Assignee: Industrial Technology Research Institute, Hsinchu (TW)

(21) Appl. No.: 19/432,118

(22) Filed: Dec. 24, 2025

Related U.S. Application Data
(60) Provisional application No. 63/805,325, filed on May 14, 2025.

(51) Int. Cl. G06F 11/263

(52) U.S. Cl. CPC G06F 11/263

(57) ABSTRACT

The present invention provides a method and an electronic device for autonomous mobility safety analysis. The method includes: setting scenario parameters of a test environment, and simulating multiple cases in the test environment, wherein each case corresponds to a trajectory; obtaining multiple movement parameters for each case; performing a dimensionality reduction algorithm on the movement parameters to obtain multiple key parameters; clustering the key parameters to obtain multiple groups; and, for one of the groups, generating a diagram based on the corresponding movement parameters.

### CROSS-REFERENCE TO RELATED APPLICATION

This application claims the priority benefit of U.S. provisional application Ser. No. 63/805,325, filed on May 14, 2025. The entirety of the above-mentioned patent application is hereby incorporated by reference herein and made a part of this specification.

### BACKGROUND

### Technical Field

The present disclosure relates to an autonomous mobility safety analysis method and an electronic device capable of providing an intuitive diagram.

### Related Art

In the development of autonomous driving technology, how to effectively analyze driving-related data has always been an important and challenging topic. Autonomous driving systems typically need to process large and diverse data sources, such as vehicle speed, steering angle, acceleration, environmental information, and traffic conditions. In addition to autonomous driving, in the fields of mobile platform such as drones and robots, various data related to movement also need to be analyzed. These data not only have high complexity in spatial dimensions, but also contain time series characteristics, making data analysis more difficult. Due to the continuity and dynamics of the movement of autonomous vehicles, drones, and robots, traditional analysis methods based on static data are difficult to accurately describe decision-making processes or behavior patterns. Therefore, in the existing technology, research and development engineers often face difficulties in extracting useful features from large amounts of time-series-related data, understanding behavior patterns, and performing visual presentations. The lack of intuitive and interactive analysis methods not only reduces data interpretation efficiency, but also limits the speed of system development and optimization.

### SUMMARY

The present disclosure proposes an autonomous mobility safety analysis method and an electronic device, capable of providing an intuitive diagram to analyze the safety of autonomous movement.

In an embodiment of the present disclosure, the autonomous mobility safety analysis method includes: setting scenario parameters of a test environment, and simulating a plurality of cases in the test environment, wherein each case corresponds to a trajectory; obtaining a plurality of movement parameters of each case; executing a dimensionality reduction algorithm on the movement parameters to obtain a plurality of key parameters; clustering the key parameters to obtain a plurality of groups; and for one of the groups, generating a diagram according to the corresponding movement parameters.

An embodiment of the present disclosure also proposes an electronic device, including a memory and a processor. The memory stores a plurality of instructions. The processor is electrically connected to the memory for executing the instructions to perform the above-mentioned autonomous mobility safety analysis method.

To make the above-mentioned features and advantages of the present invention more obvious and understandable, embodiments are specifically described below in conjunction with the accompanying drawings as follows.

### BRIEF DESCRIPTION OF THE DRAWINGS

FIG. 1 is a schematic diagram illustrating an electronic device according to an embodiment.

FIG. 2 is a flowchart illustrating an autonomous mobility safety analysis method according to an embodiment.

FIG. 3 is a schematic diagram illustrating a test environment according to an embodiment.

FIG. 4 is a schematic diagram illustrating a space formed by 2 functional principal components according to an embodiment.

FIG. 5 is a heatmap illustrating different groups according to an embodiment.

FIG. 6 is a diagram illustrating the number of groups according to an embodiment.

FIG. 7 is a diagram illustrating whether a collision occurs according to an embodiment.

FIG. 8 is a diagram illustrating selection of partial cases according to an embodiment.

FIG. 9 is a diagram illustrating playback trajectories according to an embodiment.

### DESCRIPTION OF THE EMBODIMENTS

Some embodiments of the present invention will be described in detail below with reference to the accompanying drawings. The element symbols referenced in the following description, when the same element symbols appear in different drawings, will be regarded as the same or similar elements. These embodiments are only a part of the present invention and do not disclose all possible implementations of the present invention. More precisely, these embodiments are only examples of the systems and methods in the scope of patent claims of the present invention.

Regarding “first”, “second”, etc. used herein, they do not specifically refer to order or sequence, but are merely used to distinguish elements or operations described with the same technical terms.

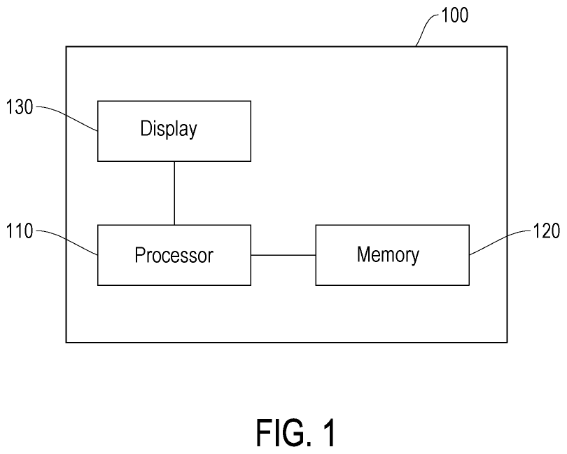

FIG. 1 is a schematic diagram illustrating an electronic device according to an embodiment. Please refer to FIG. 1, the electronic device 100 may be a smartphone, a tablet computer, a personal computer, a notebook computer, a server, a distributed computer, a cloud server, an industrial computer, or various electronic devices with computing capability, etc., and the present invention is not limited thereto. The electronic device 100 includes a processor 110, a memory 120, and a display 130, and the processor 110 is electrically connected to the memory 120 and the display 130. The processor 110 may include a central processing unit, a microprocessor, a microcontroller, a graphics processing unit (GPU), a deep-learning processing unit (DPU), a neural network processing unit (NPU), a tensor processing unit (TPU), Application Specific Integrated Circuits (ASIC), or Programmable Logic Device (PLD). The memory 120 may include random access memory, read-only memory, flash memory, floppy disk, hard disk, optical disk, USB flash drive, or magnetic tape, in which a plurality of instructions are stored, and the processor 110 executes these instructions to perform an autonomous mobility safety analysis method. The display 130 may be a liquid crystal display, a light emitting diode display, an electronic paper display, etc.

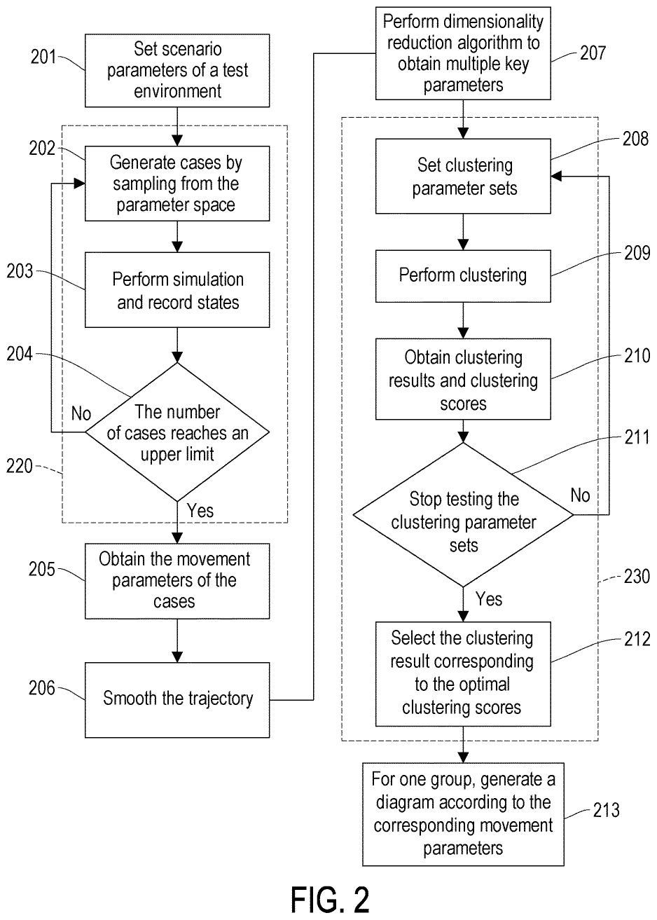

FIG. 2 is a flowchart illustrating an autonomous mobility safety analysis method according to an embodiment. Please refer to FIG. 2, steps 201 to 213 of FIG. 2 are executed by the processor 110, which will not be repeated hereinafter. The following uses an autonomous vehicle as an example to illustrate the autonomous mobility safety analysis method, but the autonomous mobility safety analysis method may also be applied to devices capable of autonomous movement such as drones, robots, etc.

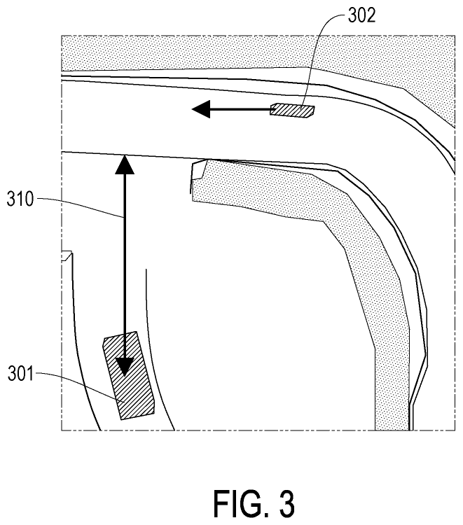

In step 201, scenario parameters of a test environment are set. The test environment includes a road and a plurality of vehicles, wherein one vehicle is referred to as an autonomous vehicle (i.e. ego vehicle), and at least one vehicle is referred to as an agent vehicle. For example, FIG. 3 is a schematic diagram illustrating a test environment according to an embodiment. In the embodiment of FIG. 3, an autonomous vehicle 301 and an agent vehicle 302 meet, and the scenario parameters include the speed of the agent vehicle 302 and a distance 310 between the autonomous vehicle 301 and the intersection. FIG. 3 is merely an example, and in other embodiments, the test environment may also be related to various road environments such as lane changing, overtaking, turning, entering an interchange, etc., and the scenario parameters may also include more speeds, angles, distances, etc. of agent vehicles. The present invention does not limit the contents of the test environment and the scenario parameters.

In applications of drones or robots, the test environment may also be an airspace or an indoor space. The test environment includes a plurality of mobile platforms, wherein one mobile platform is referred to as an autonomous mobile platform, and at least one mobile platform is referred to as an agent mobile platform. The scenario parameters may include the speed of the agent mobile platform. In the following description, the autonomous mobile platform refers to a vehicle, drone, or robot that determines actions by itself, the agent mobile platform may include other vehicles, drones, or robots. For example, in the example of FIG. 3, the autonomous vehicle 301 may be replaced with an autonomous drone or an autonomous robot, the agent vehicle 302 may be replaced with an agent drone or an agent robot, and the intersection may be replaced with any meeting area.

Please refer to FIG. 2, next in step 220, multiple cases are simulated. Specifically, the step 220 includes steps 202 to 204. In the step 202, cases are generated by sampling from the parameter space. The parameter space includes the above-mentioned scenario parameters.

In step 203, simulation is performed, and states are recorded. In other words, the autonomous mobile platform and the agent mobile platform move in the test environment according to the above-mentioned scenario parameters, and then the states of the autonomous mobile platform at each time point are recorded, and these states form the trajectory of the autonomous mobile platform. Each case corresponds to a trajectory of the autonomous mobile platform. In addition, multiple parameters are also obtained, and these movement parameters may include the speed of the autonomous mobile platform (referred to as autonomous speed), the acceleration of the autonomous mobile platform (referred to as autonomous acceleration), the angle of the autonomous mobile platform (referred to as autonomous angle), the distance between the agent mobile platform and the autonomous mobile platform (referred to as agent relative distance), and the angle of the agent mobile platform relative to the autonomous mobile platform (referred to as agent relative angle). In other embodiments, if there are more agent mobile platforms, the movement parameters may also include the distances, angles, etc. between other agent mobile platforms and the autonomous mobile platform. In applications of drones, the above-mentioned angle is the heading of the drone; in applications of robots, the angle is the steering of the robot.

In step 204, it is determined whether the number of cases reaches an upper limit (for example, 1000 or more). If the result of step 204 is no, then return to step 202 to generate another case. If the result of step 204 is yes, then step 205 is performed.

In step 205, the movement parameters of the cases are obtained. It is worth noting that each movement parameter is time series data. Specifically, the movement parameters of the i-th case at time t may be represented as

$${x}_{i} ( t ) = \{ {x}_{i}^{0} ( t ) , {x}_{i}^{1} ( t ) , {x}_{i}^{2} ( t ) , {x}_{i}^{3} ( t ) , {x}_{i}^{4} ( t ) , … \} ,$$

wherein

$${x}_{i}^{1} ( t )$$

represents the mist movement parameter, and so on.

In step 206, the trajectory corresponding to each case is smoothed. In this embodiment, p-spline is used for smoothing, but the present invention is not limited thereto. The movement parameters used in subsequent steps belong to the smoothed trajectory, which will not be described further below.

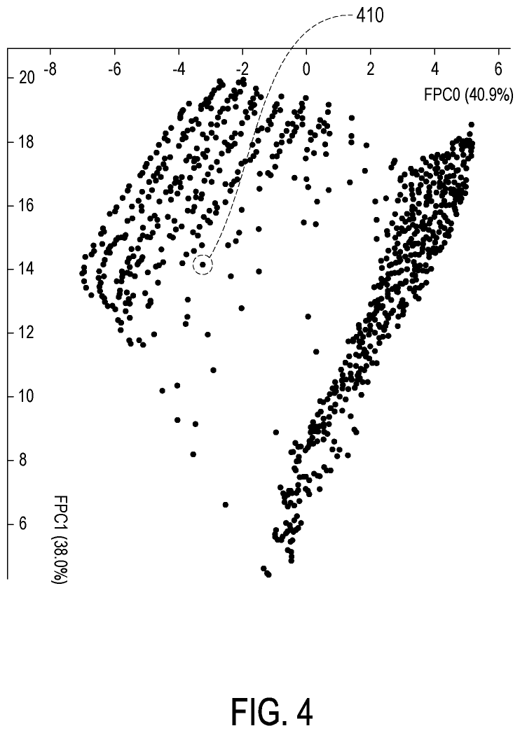

In step 207, a dimensionality reduction algorithm is performed to obtain multiple key parameters. In this embodiment, the dimensionality reduction algorithm is Multivariate Functional Principal Component Analysis (MFPCA). Generally speaking, multivariate functional principal component analysis is to find multiple functional principal components (FPC), each functional principal component is a time function, and the functional principal component may also be referred to as a basis. Here, N functional principal components with the most concentrated energy may be taken, wherein N is a positive integer, for example N=2, but the present invention is not limited thereto. After the movement parameters are projected onto these functional principal components, the score of each functional principal component may be obtained (also representing the component on each basis after projection). In this example N=2, therefore there are two key parameters in total. FIG. 4 is a schematic diagram of a space formed by 2 functional principal components according to an embodiment. Referring to FIG. 4, the horizontal axis represents the first functional principal component, and this basis represents 40.9% of the energy. The vertical axis represents the second functional principal component, and this basis represents 38.0% of the energy. In other words, these two bases represent 78.9% of the energy, which is sufficient to represent most of the data. Each coordinate point (for example, coordinate point 410) in this space is a case, and the X coordinate and Y coordinate of this coordinate point 410 are the above-mentioned key parameters.

Referring to FIG. 2, next in step 230, the key parameters are clustered to obtain multiple groups. Specifically, step 230 includes steps 208-212. In step 208, multiple clustering parameter sets are set. The clustering algorithm used in this embodiment is Density-Based Spatial Clustering of Applications with Noise (DBSCAN), therefore the clustering parameters that need to be set include the minimum number of groups, the minimum number of samples, and the radius of the groups, and these clustering parameters form a clustering parameter set. In other embodiments, other clustering algorithms may also be used, and thus different clustering parameters need to be set. For example, if the K-means algorithm is used, the number of groups needs to be set.

In step 209, the key parameters are clustered according to the clustering parameter sets. In step 210, clustering results and clustering scores are obtained. The clustering results are used to indicate which group each case belongs to. The clustering score is, for example, Silhouette Score, Calinski-Harabasz Index (CH Index), relative validity, or Davies-Bouldin Index (DBI), and the present invention is not limited thereto. In step 211, it is determined whether to stop testing the clustering parameter sets. In some embodiments, grid search may be used to find all clustering parameter sets, and when there are clustering parameter sets that have not been tried yet, the determination result of step 211 is no. In some embodiments, the clustering parameter sets may also be iteratively and randomly generated, and then it is determined whether the number of iterations has reached an upper limit. If the result of step 211 is no, then return to step 208 to try the next clustering parameter set. If the result of step 211 is yes, then step 212 is performed to select the clustering result corresponding to one or more optimal clustering scores among all clustering scores.

In step 213, for one of the groups (or all of the groups), at least one diagram is generated according to the movement parameters corresponding to this group. In this example, since the cases have been clustered, the characteristics of each group may be observed through the diagrams. In addition, the dimensionality reduction algorithm may filter out some noise, and may also present these cases in a more intuitive manner in low dimensions (for example, FIG. 4). The above-mentioned diagrams are plotted on a user interface, and the display 130 displays this user interface, and the user may interact through a mouse, keyboard, or touch. Various diagrams will be illustrated with a plurality of embodiments below.

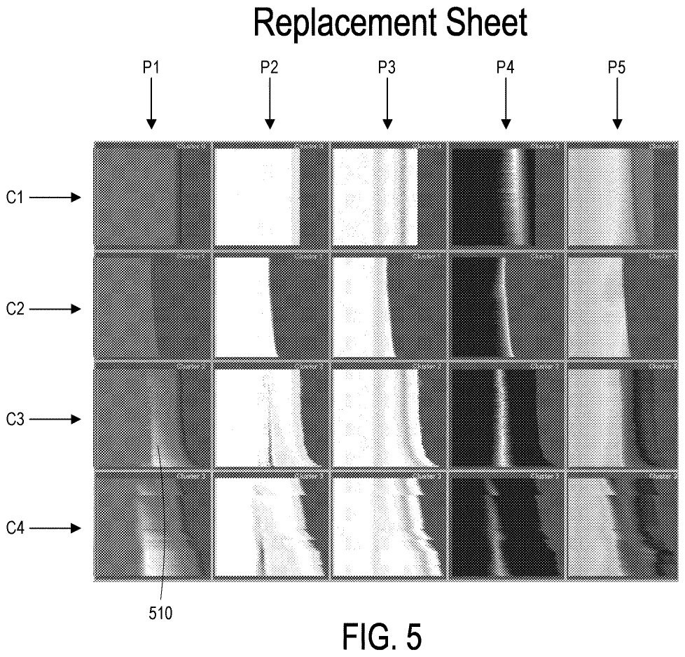

FIG. 5 is a diagram illustrating heatmaps of different groups according to an embodiment. Please refer to FIG. 5, a total of 20 heatmaps are illustrated here, wherein rows C1-C4 represent four different groups. For convenience of illustration and analysis, the user names the group of row C1 as “pass first (no yielding)”; names the group of row C2 as “collide”; names the group of row C3 as “delayed yielding”; names the group of row C4 as “advance yielding”. These names may generally represent the behaviors of the autonomous mobile platforms in the corresponding groups. On the other hand, columns P1-P5 represent 5 different movement parameters, which in this example are autonomous speed, autonomous acceleration, autonomous angle, agent relative distance, and agent relative angle, respectively.

Here is an explanation of how to draw a heatmap. Taking the heatmap 510 located at the row C3 and column P1 as an example, first the cases belonging to this group are obtained, and then the similarity of each of these cases is calculated. In some embodiments, Uniform Manifold Approximation and Projection (UMAP) may be adopted to project each case onto a one-dimensional space, and then sort these cases according to the similarities calculated in UMAP. The vertical axis on the heatmap is the sorted cases, for example, from top to bottom are the case with the highest similarity to the case with the lowest similarity. Next, the movement parameter of each case (column P1 corresponds to autonomous speed) is plotted on the horizontal axis of the heatmap with respect to time. Here, different grayscales or colors may be used to represent the magnitude of autonomous speed. In the heatmap 510, the brighter parts indicate that the speed of the autonomous vehicle is lower, usually reflecting that the autonomous vehicle is decelerating or maintaining a low-speed state. Referring to the heatmap located at row C1 and column P1, the autonomous speed does not change significantly in this group; referring to the heatmap located at row C2 and column P1, the autonomous speed also does not change significantly in this group. However, in the heatmap 510, since the autonomous vehicles in this group have “delayed yielding”, the agent mobile platforms are allowed to pass through the intersection area. Referring to the heatmap located at row C4 and column P1, the autonomous speed also decreases in this group, because the autonomous vehicles have “advance yielding” behavior. Similarly, different behavior patterns may also be observed in other heatmaps.

In some embodiments, these generated heatmaps may also be used to adjust the clustering parameters in return. For example, the heatmaps may be input to a machine learning model (such as a convolutional neural network). During training, the output of the machine learning model is a score provided by the user to indicate whether the multiple cases in the heatmap are consistent with each other. In some embodiments, the proportion of collisions occurring among the multiple cases in the heatmap may also be used as the score, with the purpose of generating groups where no collisions occur at all (or where every case has a collision). Then, the output of the machine learning model during inference is used as a reward, and a reinforcement learning is executed to adjust the parameters in the clustering parameter set. This reinforcement learning is, for example, Q-learning or SARSA algorithm, and the present invention is not limited thereto.

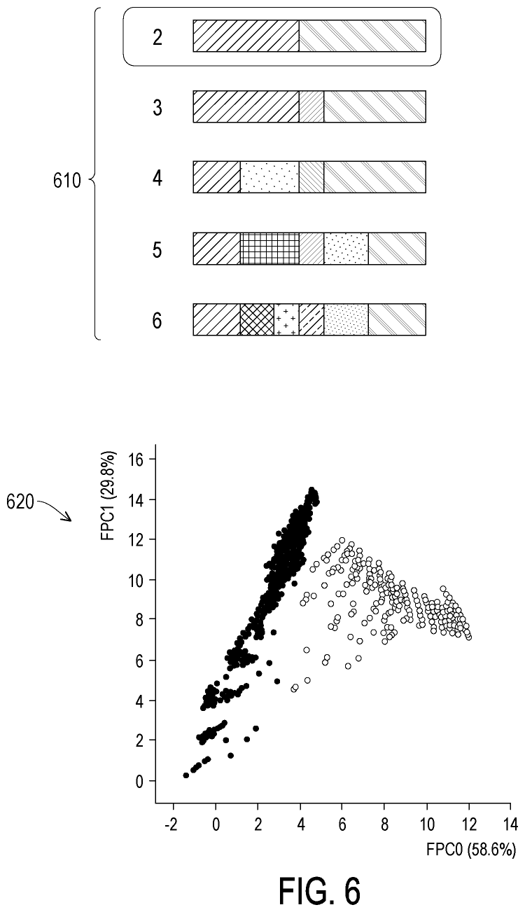

FIG. 6 is a diagram illustrating the number of groups according to an embodiment. In the embodiment of FIG. 6, the diagram is used to provide clustering results. For example, the diagram 610 is used to indicate how many cases are in each group when the number of clusters is 2, 3, 4, 5, 6 (the more cases, the longer the corresponding bar). When the user clicks on one of the bars, the clustering results may be displayed in the diagram 620, for example, using two bases (i.e. functional principal components) in the dimensionality reduction algorithm as the X-axis and Y-axis, and then projecting all the cases onto the diagram 620.

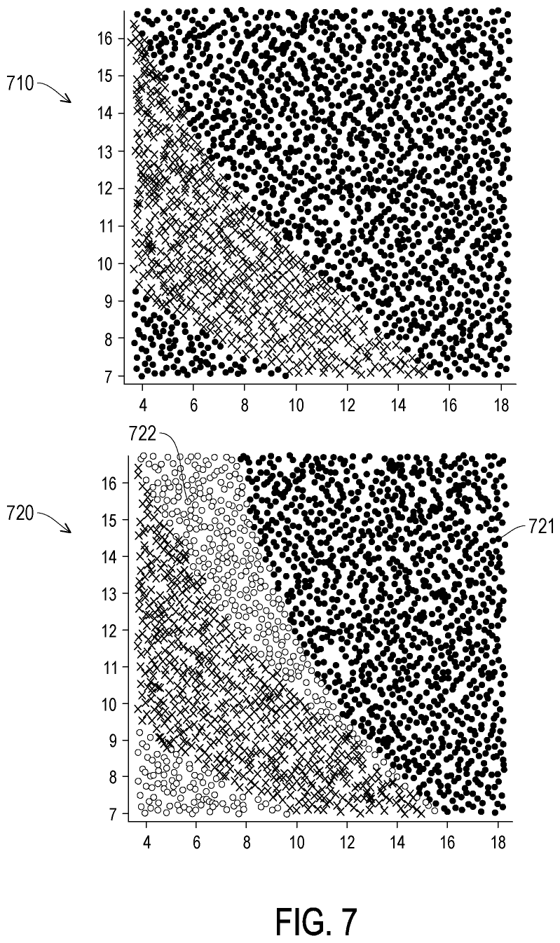

In some embodiments, the diagram is used to display cases and mark whether collisions occur in the cases. FIG. 7 is a diagram illustrating whether collisions occur according to an embodiment. Referring to FIG. 7, in the diagram 710, the horizontal axis and the vertical axis are two scenario parameters, respectively, such as the speed of the agent vehicle 302 and the distance 310 between the autonomous vehicle 301 and the intersection (referring to the description of FIG. 3). In addition, whether a collision occurs between the autonomous vehicle and the agent vehicle is marked in the diagram 710, where circles represent no collision, and crosses “X” represent collisions. The user may directly click on one or more cases in the diagram 710 to view related data. In addition, the X-axis and Y-axis in the diagram 720 are also scenario parameters, but are used to display clustering results, where different colors may be used to represent different groups. For example, a case 721 belongs to the first group, and a case 722 belongs to the second group. By combining the diagrams 710, 720, the relationship between clustering and collisions may be observed.

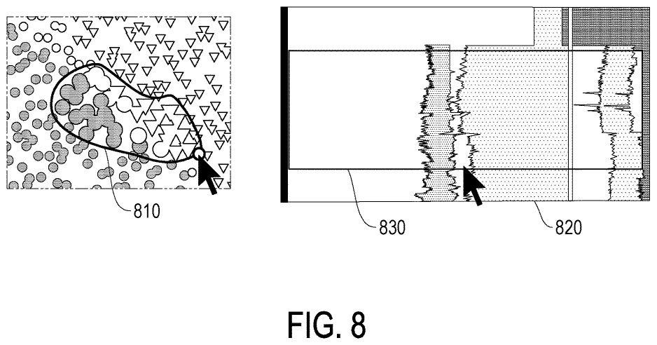

FIG. 8 is a diagram illustrating selecting partial cases according to an embodiment. Referring to FIG. 7 and FIG. 8, the user may select a region 810 in the diagram 710 or the diagram 720, and then the system will automatically present related information of the cases within this region 810. For example, a corresponding area 830 is selected in the corresponding heatmap 820.

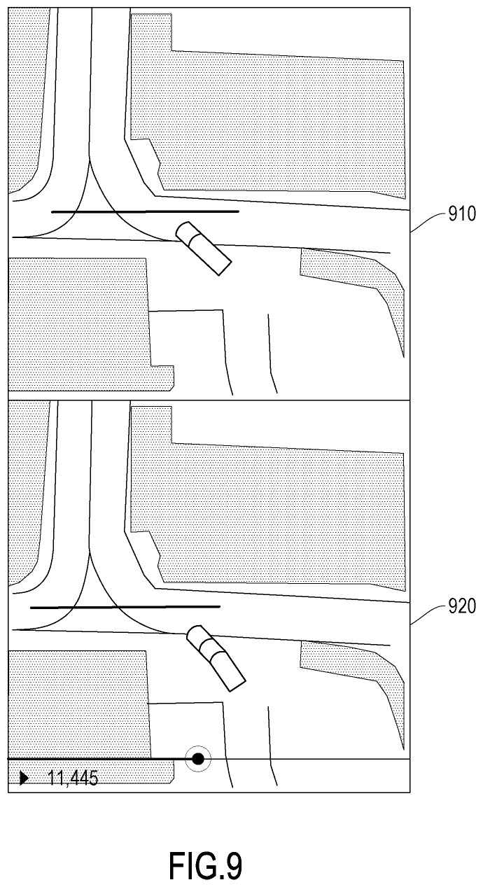

In some embodiments, the diagram may also be used to playback trajectories corresponding to a portion of the cases. FIG. 9 is a diagram illustrating playback of trajectories according to an embodiment. In the embodiment of FIG. 9, the diagrams 910 and 920 playback the trajectories of the corresponding cases in a video manner. In some embodiments, when playing back cases, the heatmap of the corresponding group may also be presented together.

In some embodiments, the above clustering results may also be used during online (inference) phase, that is, applied in the control logic of the autonomous mobile platform. Specifically, when the autonomous mobile platform moves, related multiple movement parameters may be collected (forming an online case). Then, the movement parameters of the online case are projected onto multiple bases of the above dimensionality reduction algorithm to obtain multiple online key parameters. For example, if 2 bases are adopted, the online case will be projected onto two online key parameters in a two-dimensional space. Next, the online key parameters are assigned to one of the above multiple groups. For example, in the embodiment of FIG. 5, the online case may be assigned to one of four groups such as “pass first (no yielding)”, “collide”, “delayed yielding”, and “advance yielding”. If the online key parameters are assigned to the “collide” group, a warning message may be provided, and corresponding operations may be taken according to this warning message, such as deceleration, hovering, lowering altitude, evasion, etc. If the online key parameters are assigned to other groups, it indicates that there is no danger of collision, and a safety message is provided to maintain the original movement logic unchanged.

In the above autonomous mobility safety analysis method and electronic device, the user may observe the differences between different groups from the projected space after dimensionality reduction, and may also observe the clustering results from the heatmap. In some diagrams, whether collision occurs is marked, and high-risk behavior regions (at the edge of collision/non-collision) may also be identified from this diagram, and related data of these cases may be directly observed through the user interface. Through various diagrams, the user may also perform operations such as case playback. In addition, the above clustering results may also be applied to online cases, providing warning messages or safety messages in a timely manner.

Although the present invention has been disclosed above with embodiments, it is not intended to limit the present invention. Any person having ordinary knowledge in the technical field may make some modifications and refinements without departing from the spirit and scope of the present invention. Therefore, the protection scope of the present invention shall be defined by the appended claims.

What is claimed is:

1. A safety analysis method for analyzing and optimizing a mobility behavior of an algorithm of an autonomous mobile system, executed by an electronic device, the autonomous mobility safety analysis method comprising:
setting at least one scenario parameter of a test environment, and simulating a plurality of cases in the test environment, wherein each of the cases corresponds to a trajectory;
obtaining a plurality of movement parameters of each of the cases;
performing a dimensionality reduction algorithm on the movement parameters to obtain a plurality of key parameters;
grouping the key parameters to obtain a plurality of groups; and
for one of the groups, generating at least one diagram according to the corresponding movement parameters.

2. The autonomous mobility safety analysis method according to claim 1, further comprising:
for each of the cases, smoothing the corresponding trajectory, wherein the movement parameters belong to the smoothed trajectory, the movement parameters comprise an autonomous velocity, an autonomous acceleration, an autonomous angle, an agent relative distance, and an agent relative angle.

3. The autonomous mobility safety analysis method according to claim 1, wherein the dimensionality reduction algorithm is a multivariate functional principal component analysis.

4. The autonomous mobility safety analysis method according to claim 1, wherein the step of grouping the key parameters to obtain the groups comprises:
setting a plurality of clustering parameter sets;
grouping the key parameters according to each of the clustering parameter sets to obtain a clustering result and a clustering score; and
selecting the clustering result corresponding to an optimal clustering score of the clustering scores.

5. The autonomous mobility safety analysis method according to claim 4, wherein the step of for one of the groups, generating at least one diagram according to the corresponding movement parameters comprises:
for a first group of the groups, calculating a similarity of each of a plurality of first cases of the first group;
sorting the first cases according to the similarities; and
plotting one of the movement parameters in a heatmap with respect to time according to the sorted first cases.

6. The autonomous mobility safety analysis method according to claim 5, further comprising:
inputting the heatmap to a machine learning model to obtain a score; and
adjusting one of the clustering parameter sets according to the score.

7. The autonomous mobility safety analysis method according to claim 1, wherein the step of for one of the groups, generating at least one diagram according to the corresponding movement parameters comprises:
providing a first diagram, a second diagram, or a third diagram in a user interface,
wherein the first diagram is configured to display the cases, and marking whether a collision occurs in the cases.

8. The autonomous mobility safety analysis method according to claim 7, wherein the second diagram is configured to display a selected portion of the cases,
wherein the third diagram is configured to replaying the trajectories corresponding to a portion of the cases.

9. The autonomous mobility safety analysis method according to claim 1, further comprising:
obtaining an online case, and obtaining a plurality of online movement parameters of the online case;
projecting the online movement parameters onto a plurality of bases of the dimensionality reduction algorithm to obtain a plurality of online key parameters;
assigning the online key parameters to one of the groups;
when the online key parameters are assigned to one of the groups, providing a warning message; and
when the online key parameters are assigned to another one of the groups, providing a safety message.

10. An electronic device, comprising:
a memory, storing a plurality of instructions; and
a processor, electrically connected to the memory, and configured to execute the instructions to perform a plurality of steps:
setting at least one scenario parameter of a test environment, and simulating a plurality of cases in the test environment, wherein each of the cases corresponds to a trajectory;
obtaining a plurality of movement parameters of each of the cases;
performing a dimensionality reduction algorithm to the movement parameters to obtain a plurality of key parameters;
clustering the key parameters to obtain a plurality of groups; and
for one of the groups, generating at least one diagram according to the corresponding movement parameters.

11. The electronic device according to claim 10, wherein the steps further comprise:
for each of the cases, smoothing the corresponding trajectory, wherein the movement parameters belong to the smoothed trajectory, and the movement parameters comprise an autonomous velocity, an autonomous acceleration, an autonomous angle, an agent relative distance, and an agent relative angle.

12. The electronic device according to claim 10, wherein the dimensionality reduction algorithm is a multivariate functional principal component analysis.

13. The electronic device according to claim 10, wherein the step of clustering the key parameters to obtain the groups comprises:
setting a plurality of clustering parameter sets;
clustering the key parameters according to each of the clustering parameter sets to obtain a clustering result and a clustering score; and
selecting the clustering result corresponding to an optimal clustering score of the clustering scores.

14. The electronic device according to claim 13, wherein the step of for one of the groups, generating at least one diagram according to the corresponding movement parameters comprises:
for a first group of the groups, calculating a similarity of each of a plurality of first cases of the first group;
sorting the first cases according to the similarities; and
plotting one of the movement parameters in a heatmap with respect to time according to the sorted first cases.

15. The electronic device according to claim 14, wherein the steps further comprise:
inputting the heatmap to a machine learning model to obtain a score; and
adjusting one of the clustering parameter sets according to the score.

16. The electronic device according to claim 10, wherein the step of for one of the groups, generating at least one diagram according to the corresponding movement parameters comprises:
providing a first diagram, a second diagram, or a third diagram in a user interface,
wherein the first diagram is configured to display the cases, and marking whether a collision occurs in the cases.

17. The electronic device according to claim 16, wherein the second diagram is configured to display a selected portion of the cases,
wherein the third diagram is configured to replay the trajectories corresponding to a portion of the cases.

18. The electronic device according to claim 10, wherein the steps further comprise:
obtaining an online case, and obtaining a plurality of online movement parameters of the online case;
projecting the online movement parameters onto a plurality of bases of the dimensionality reduction algorithm to obtain a plurality of online key parameters;
assigning the online key parameters to one of the groups;
when the online key parameters are assigned to one of the groups, providing a warning message; and
when the online key parameters are assigned to another one of the groups, providing a safety message.
